(19) United States
(12) Patent Application Publication
(10) Pub. No.: US 2008/0072827 A1
(43) Pub. Date: Mar. 27, 2008

(54) Elevated pet feeding furniture

(76) Inventors: Christopher Haroutoun Bohjalian, Stevenson Ranch, CA (US); Michael Dennis Finley, Stevenson Ranch, CA (US)

Correspondence Address: Christopher H. Bohjalian, Suite 114, 25129 The Old Road, Stevenson Ranch, CA, 91381, US

(21) Appl. No.: 11/514,061

(22) Filed: Sep. 1, 2006

(51) Int. Cl. A01K 29/00

(52) U.S. Cl. 119/28.5

(57) ABSTRACT

This invention is an elevated article of furniture that may be voluntarily accessed by a pet to feed or be fed, or for other purposes. It is elevated off the ground by a base; is accessible by stairs, a ramp, or a motorized lift (depending on the pet's needs or owner's preference); has a seat for the pet; is enclosed partially on the sides to help prevent falls and for resting; has a removable padded cover for the seat; and has a tray or food holder for the pet's food and drink, directly or in dishes. It may be built as a fixed or folding piece of furniture. This invention is useful for establishing a feeding location for the pet, discouraging “begging” at the table, placing the pet at a more convenient level for the pet owner, reducing pet hair and messes on furniture, and nurturing a family bond.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

This invention is in the field of furniture designed for pets, Classification 119/28.5, more specifically, furniture designed to provide a pet with an elevated feeding location with voluntary access thereto and egress therefrom and a holder or tray from which the food may be dispensed.

2. Description of the Prior Art

The field of pet furniture has produced numerous patents, none of which bear any significant similarity to this invention. The Trahd-Morris Sling bed for pets No. D443,733 is a design patent for an ornamental pet sling bed. The Fife, et al., self-covering pet bed U.S. Pat. No. 5,000,116, the Morgan pet bed No. D423,729, the Caldwell pet bed with a detachable, washable sleeping surface U.S. Pat. No. 5,860,389; the Michaelis pet bed or similar article and method of making the same U.S. Pat. No. 6,286,456; the Schwarzenbart pet bed U.S. Pat. No. 5,197,411; the Ford human shaped pet bed U.S. Pat. No. 6,305,318; the McAllister cushions for household pets U.S. Pat. No. 5,515,811 and U.S. Pat. No. 5,363,804; the McAlister bed for a household pet U.S. Pat. No. 5,724,911; the Duane collapsible, portable pet rest attachable to a bed U.S. Pat. No. 5,161,484; the McMahon bed for pets No. D396,332; are pet sleeping apparatuses only. The O'Donnell Portable pet booster seat apparatus U.S. Pat. No. 5,551,373 is intended to fasten a pet into a motor vehicle for travel. The Ayers, Jr., Pet-accessed lighted ramp assembly U.S. Pat. No. 6,691,645; the Bishop pet ramp U.S. Pat. No. 6,968,810; the Sloan, et al., pet ramp U.S. Pat. No. 5,213,060; Holbrook folding pet ramp No. D382,676; are separate ramps that are placed next to furniture for a pet to access the separate piece of furniture. Similarly, the Wolfington, et al., pet step and method U.S. Pat. No. 6,964,246, constitutes a separate set of stairs or steps that are placed next furniture to facilitate a pet's access to that separate piece of furniture. The Stewart pet lounge U.S. Pat. No. 4,860,689 is more like a sofa or a bed for a pet, intended for a pet to lounge or rest on it, not for a pet to feed or be fed. The Home pet chair No. D314,252, is a design patent for an ornamental pet chair design that does not conflict with this invention. The Sherman, et al., multi-use pet environment U.S. Pat. No. 6,513,456 is a specially designed animal pen that keeps an animal in an enclosed area, not an article of furniture that a pet can voluntarily access for feeding and other purposes. The Willinger, et al., modular pet furniture U.S. Pat. No. 5,806,464 is a series of columns and shapes that a pet such as a cat may climb on and rest on, but it is not an item of elevated pet feeding furniture. The Delzio cat scratching post feeder U.S. Pat. No. 5,113,795 is a cat scratching post that also dispenses cat food, but it is not an elevated piece of furniture with a ramp or stairs for the pet, a seat, an enclosure, and a tray for food like this invention. The Holbrook combined pet stool and ramp No. D322,872 is a design patent for a device that does provide an elevated seating surface for a pet, as well as a ramp for the pet to access the furniture voluntarily, but it has no special adaptations for feeding a pet and does not patent the utility of a raised furniture item with a ramp.

### BRIEF SUMMARY OF THE INVENTION

This invention is designed to give a pet its own furniture on which to feed, although the pet could easily rest or lounge on the furniture, as well. It provides an elevated seat, a simple access route for the pet to enter and leave the seat of its own will, a partial enclosure to help protect the pet from falling out of the seat, a tray or holder for food and drink, and a padded seat cover for the pet's comfort. It helps the pet owner or trainer address several problems, including: (1) a tool to help discourage begging at the dinner table, (2) a tool to help discourage pets from using furniture intended for humans, (3) an elevated place for each pet to feed or be petted separately from other pets, and (4) a space for the pet to consider its own, helping it to feel like an important member of the family.

### BRIEF DESCRIPTION OF THE DRAWINGS

FIG. 1 is an angled front view of the invention in fixed form.

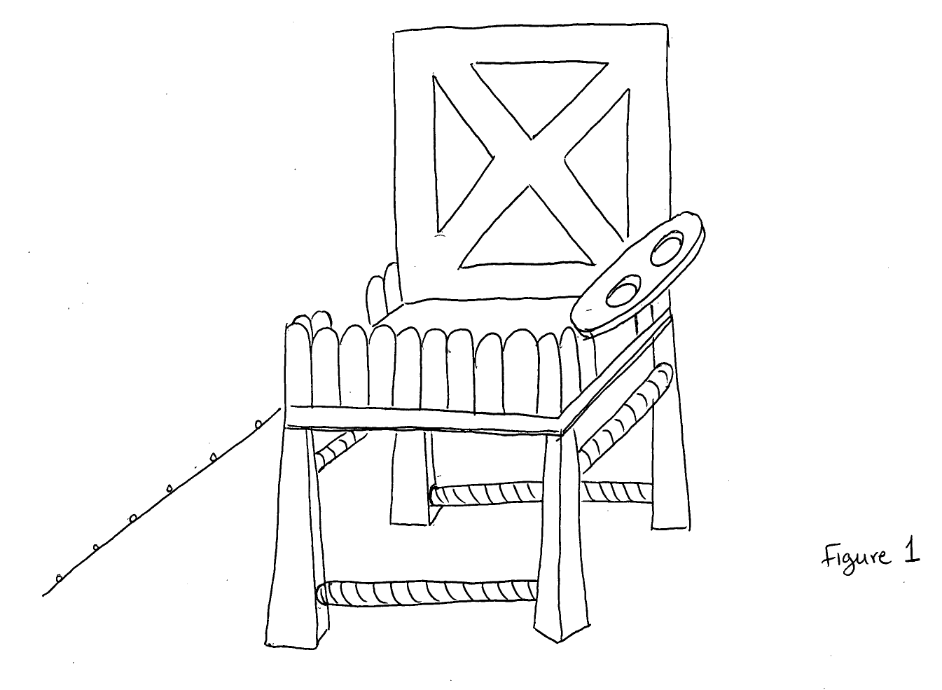

FIG. 2 is an angled side view of the option of steps for pet access and egress from the seat.

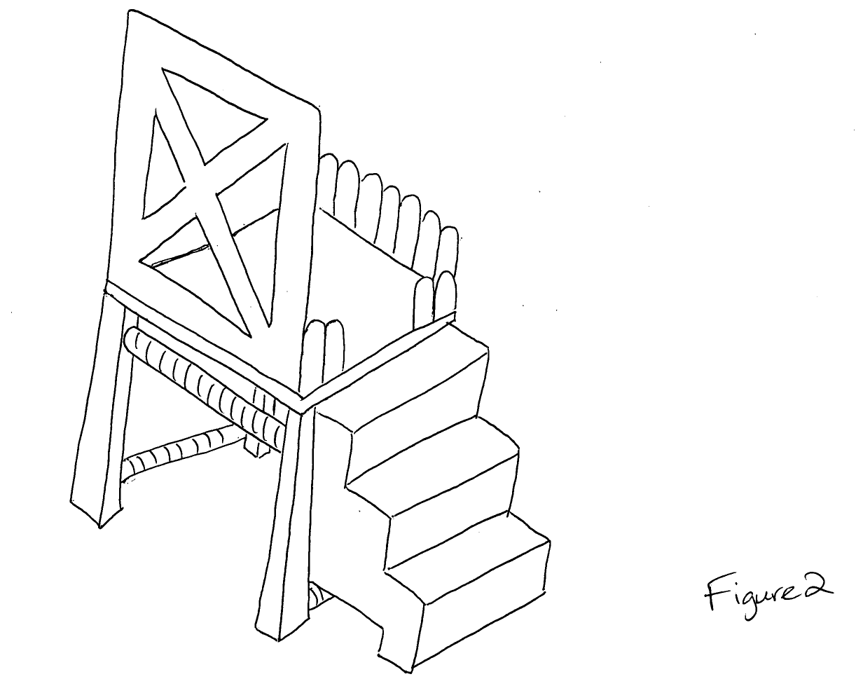

FIG. 3 is an angled side view of the option of a ramp for pet access and egress from the seat.

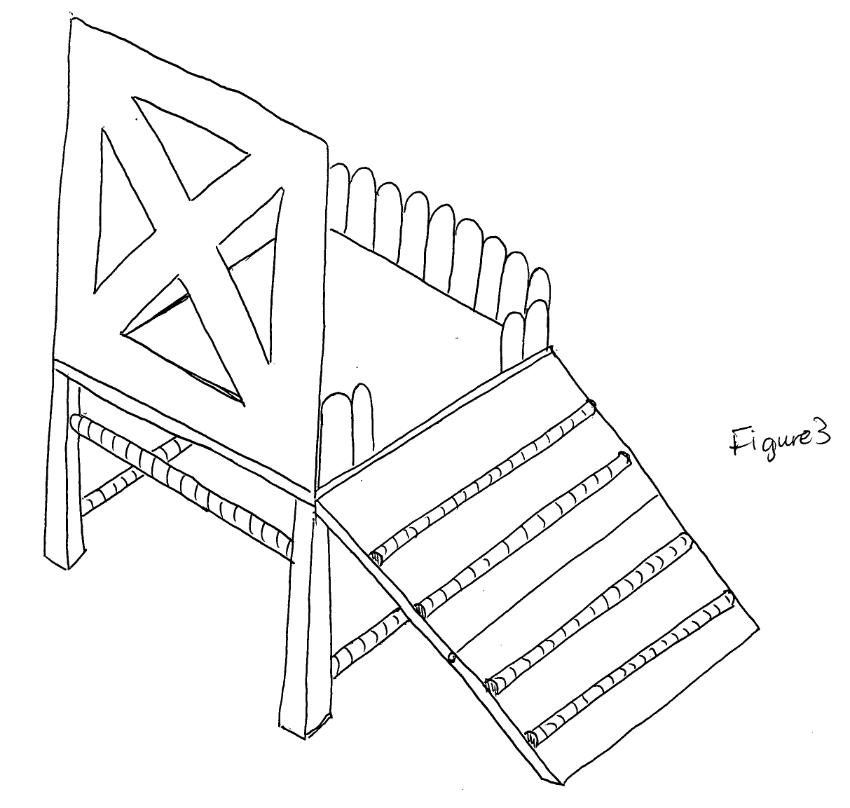

FIG. 4 is an angled overhead view of the seat portion of the invention with partial enclosure.

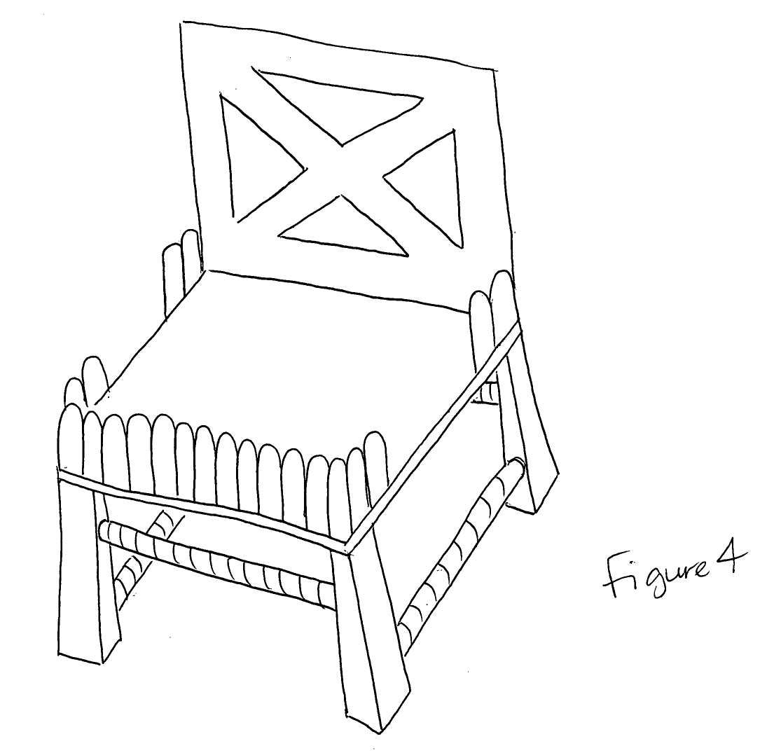

FIG. 5 is an angled overhead view of the seat portion of the invention with a removable, washable cover in place.

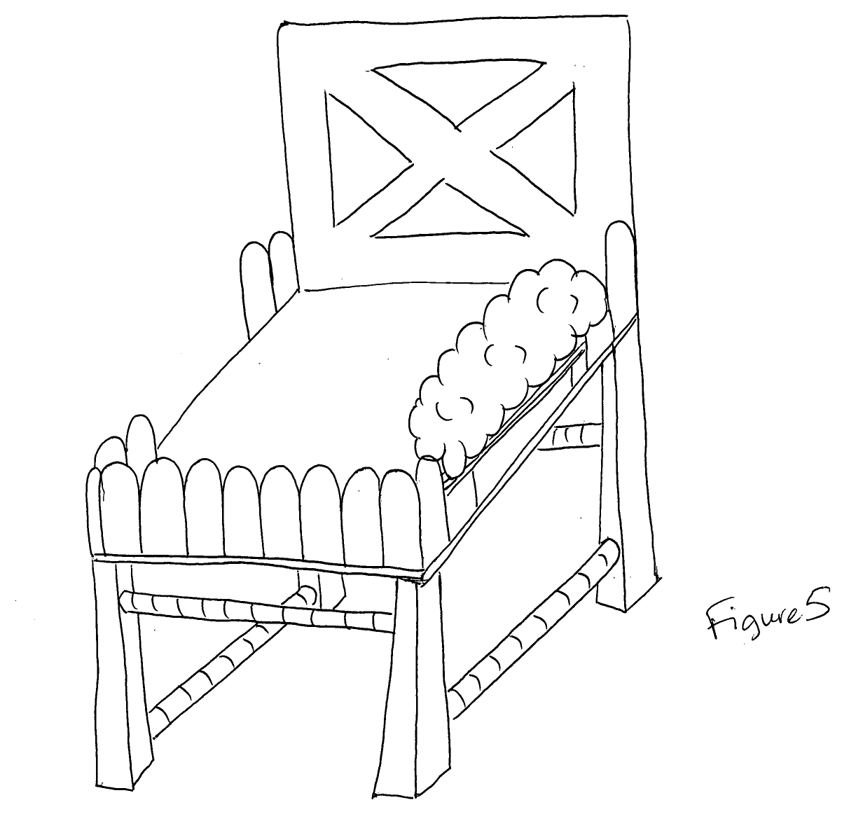

FIG. 6 is an overhead view of a tray option for feeding the pet.

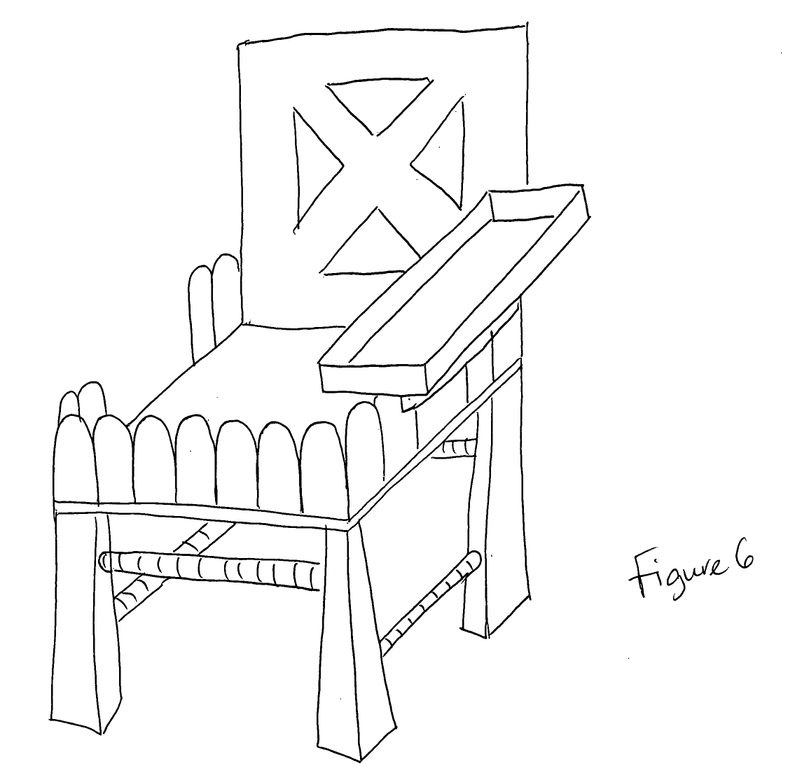

FIG. 7 is an overhead view of a food holder option for feeding the pet.

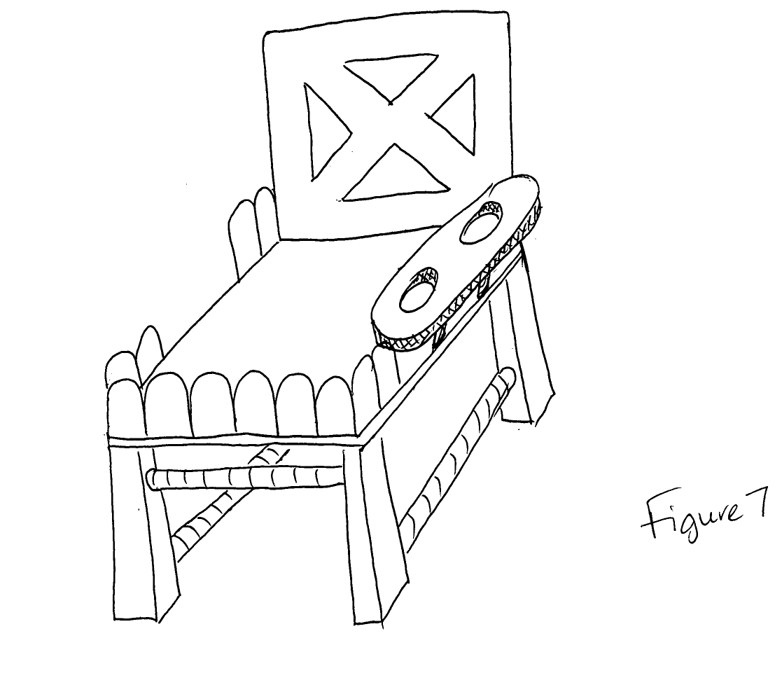

FIG. 8 is an angled side view of the invention in folding form while standing.

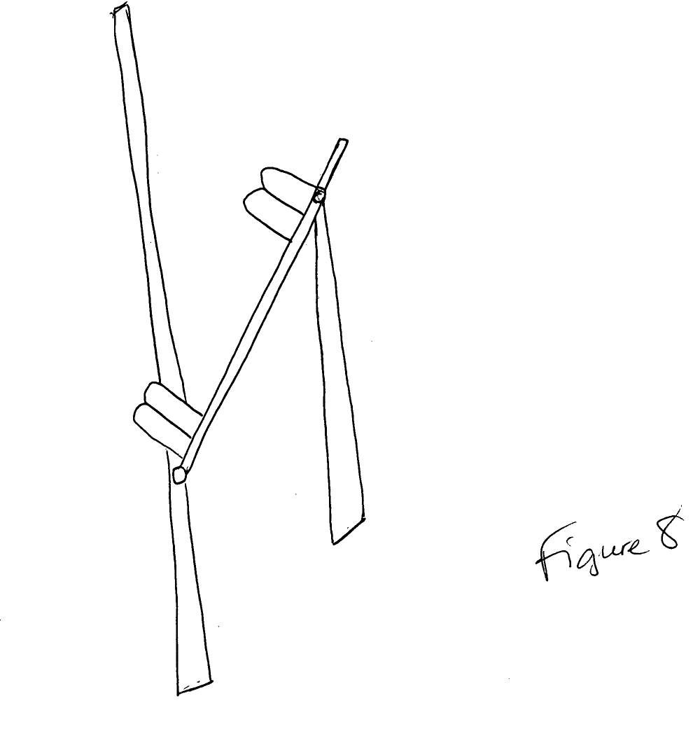

FIG. 9 is an angled side view of the invention in folding form while folded.

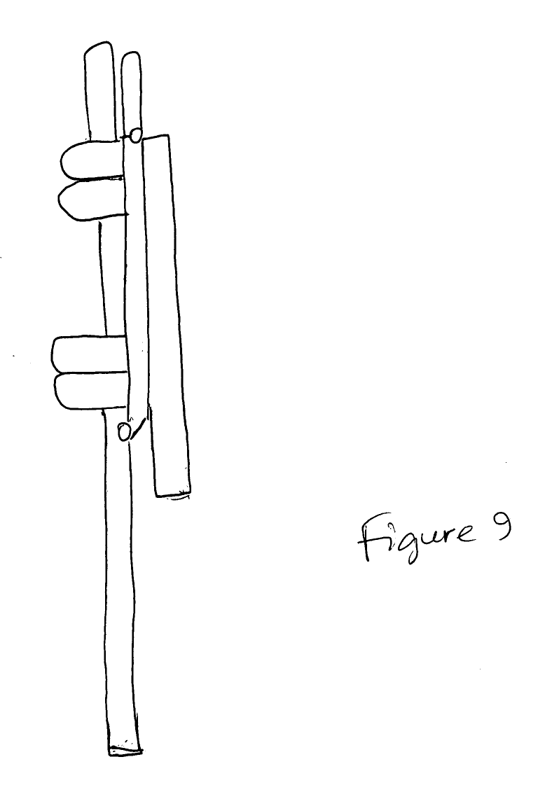

FIG. 10 is an angled side view of the invention with a motorized lift instead of a ramp or stairs.

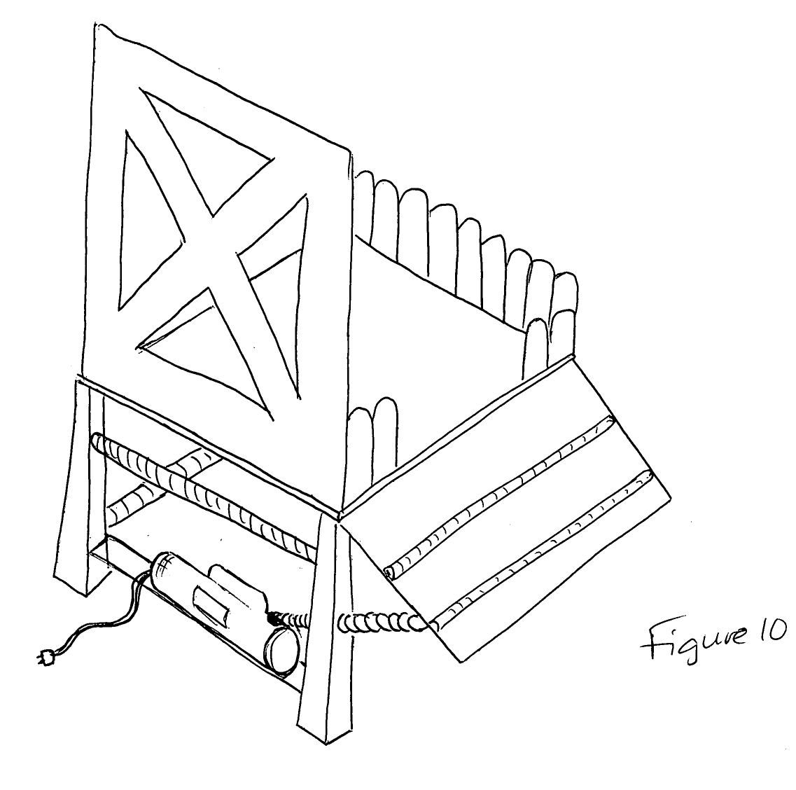

### DETAILED DESCRIPTION OF THE INVENTION

This invention has two preferred embodiments. The first is the fixed form, which consists of a seat that is elevated upon a free-standing base, the seat being partially enclosed to help prevent the pet from falling off, with stairs or a ramp or a motorized lift for the pet to access the seat (depending upon the pet's needs and the owner's preference), and a tray or holder for the pet's food and drink (again, depending upon the pet's needs or the owner's preference). The second is the folding form, which consists of a seat that is elevated upon a folding free-standing base, with a folding partial enclosure, folding stairs or ramp, and a folding tray or holder for the pet's food and drink. The most important elements are the elevation of the seat, the partial enclosure of the pet (leaving room for access to the stairs or ramp and tray or food holder), the stairs or ramp for the pet's access to and from the seat, and the tray or holder for the pet's food and drink. In fixed form, several incarnations are possible. For example, it could be made out of wood with the base made of four legs similar to furniture for humans, with a wooden seat, a wooden enclosure, wooden stairs or ramp, and a wooden or plastic or metal tray or food holder. As another example, the entire invention could be molded out of plastic, with a base that would look solid, but be hollow inside; with molded stairs leading up to the seat; with raised sides forming a partial enclosure; and with an integral tray or food holder. In the folding incarnation, the invention could be made out of any suitable material, with folding legs similar to a folding chair or folding step stool, with folding steps or ramp, folding side rails alongside the seat to form the partial enclosure, and a folding tray or food holder that folds flat against the seat. In all of its forms, the invention benefits from the use of a removable, washable, padded seat cover that can also wrap over the sides of the partial enclosure.

We claim:

1. A free-standing article of pet furniture consisting of an elevated seat supported by a base, with a partial enclosure around the seat to help prevent the pet from falling off and to provide a raised surface against or on which the pet may rest, with a tray (with or without depressions in the tray to hold bowls for pet food and drink) or a food and drink holder attached to and raised slightly above the seat at a level that would allow the pet to eat and drink comfortably, with steps or a ramp or a motorized lift (depending on the pet's needs and the owner's preference) to allow the pet access to and egress from the seat, and with a washable seat cover that is padded and removable.

2. The same invention made with a folding frame to allow the furniture to be more easily transported or stored when not in use.
